(19) United States
(12) Patent Application Publication
(10) Pub. No.: US 2015/0356531 A1
(43) Pub. Date: Dec. 10, 2015

(54) DIGITAL GOOD SECONDARY MARKET PLATFORM

(71) Applicant: eBay Inc., San Jose, CA (US)

(72) Inventors: Neelakantan Sundaresan, Mountain View, CA (US); Phillip John Leslie, Venice, CA (US)

(21) Appl. No.: 14/301,266

(22) Filed: Jun. 10, 2014

(51) Int. Cl. G06Q 20/12; G06Q 30/06

(52) U.S. Cl. CPC G06Q 20/1235; G06Q 30/0601

(57) ABSTRACT

In various example embodiments, a system and method for providing a digital good secondary market platform are presented. A request to transfer a digital good may be received from a user. The digital good may be subject to an ownership restriction stored in association with the digital good. Ownership criteria associated with the ownership restriction may be determined. Based, at least in part, on the ownership criteria, the first user may be authorized to access the digital good. The transfer of the digital good may be facilitated.

### TECHNICAL FIELD

Embodiments of the present disclosure relate generally to digital goods, and more particularly, but not by way of limitation, to a digital good secondary market platform.

### BACKGROUND

Digital goods are usurping physical goods in a number of markets, as they offer cheap, near-instant delivery and effective inexhaustibility. For example, an eBook may be digitally delivered almost instantly to a nearly limitless number of consumers and will not physically degrade over time. However, the near inexhaustibility of digital goods may depress market prices for the digital goods since they lack rarity and digital goods may not be a perfect substitute for their physical counterparts in all respects.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to example embodiments.

FIG. 2 is a block diagram illustrating an example embodiment of a secondary market system, according to example embodiments.

FIG. 3 is a flow diagram illustrating an example method for managing a secondary market for digital goods, according to example embodiments.

FIG. 4 is a flow diagram illustrating communication between devices, according to example embodiments.

FIG. 5 is a flow diagram illustrating determining ownership criteria, according to example embodiments.

FIG. 6 is a flow diagram illustrating determining a price for the digital good, according to example embodiments.

FIG. 7 illustrates an example user interface for presenting a digital good, according to example embodiments.

FIG. 8 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques are not necessarily shown in detail.

Example embodiments provide systems and methods for providing a digital good secondary market. Unlike physical goods, digital goods, such as eBooks and other digital media, may not degrade over time. In addition, the supply of physical goods may be limited while the supply of a digital good is nearly limitless. To enhance price discrimination and increase demand for digital goods, a secondary market for digital goods may be integrated with a primary market for digital goods. A wide variety of ownership restrictions associated with the digital good may be implemented to create a secondary market distinct from a primary market. For example, the ownership restrictions may include limits on the number of transfers of the digital good, time limitations that allow transfer of the digital good within a time period, and/or other ownership restrictions. The ownership restrictions may be used as a basis for price differentiation.

In an example embodiment, a request to transfer the digital good may be received from a first user. The digital good may be subject to an ownership restriction stored in association with the digital good (e.g., a limit on the number of transfers of the digital good). Ownership criteria associated with the ownership restriction may be determined. The first user may be authorized to access the digital good based, at least in part, on the determined ownership criteria. Transfer of the digital good to the first user may be facilitated.

In further example embodiments, the transfer of the digital good may comprise a purchase of the digital good by the first user for a price. A commission may be added to the price. At least a portion of the commission may be allocated to the publisher of the digital good and the distributor of the digital good. In some example embodiments, the price may be determined based on the ownership restrictions. For instance, a digital good without any, or very few, ownership restrictions may correspond to a price that is higher than the price of a digital good that implements more ownership restrictions. In other example embodiments, the price may be determined based on an available inventory of the digital good. A price floor for the purchase of the digital good may be maintained to prevent purchase of the digital good for a price below the price floor. In some example embodiments, the digital good may be gifted to a specified user.

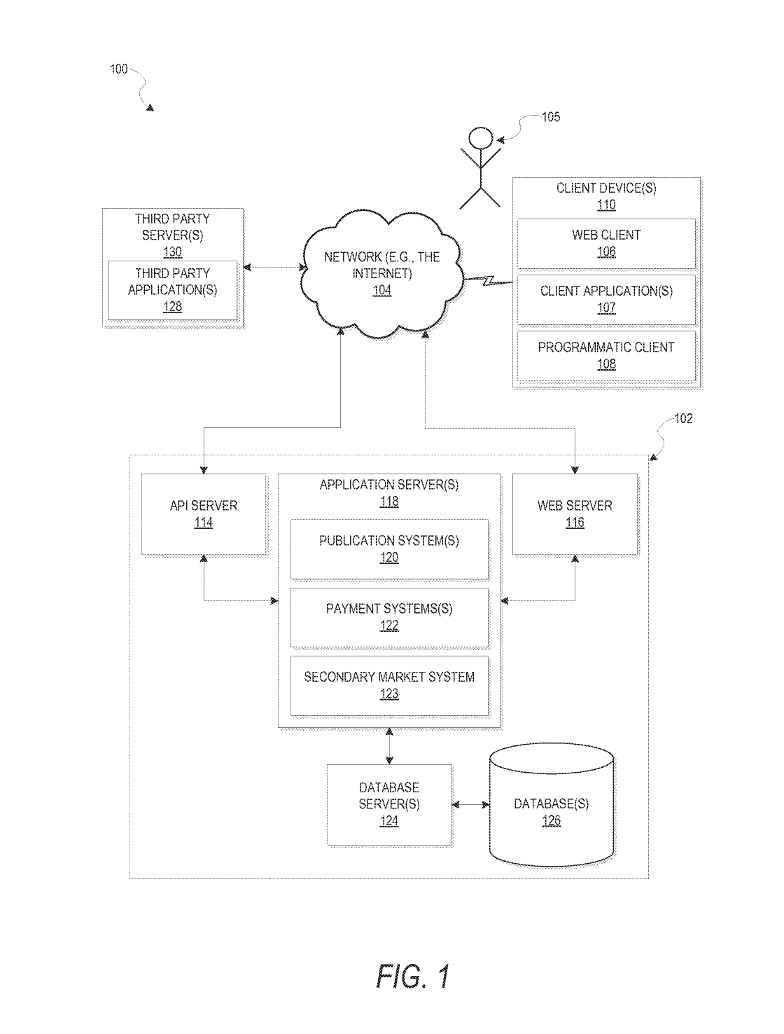

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 106 (e.g., a browser, such as the Internet Explorer) browser developed by Microsoft® Corporation of Redmond, Wash. State), client application(s) 107, and a programmatic client 108 executing on the client devices 110. The client devices 110 may include the web client 106, the client application(s) 107, and the programmatic client 108 alone, together, or in any combination. Although FIG. 1 shows one of the client devices 110, multiple device machines may be included in the network architecture 100.

The client devices 110 may comprise a computing device that includes at least a display and communication capabilities with the network 104 to access the networked system 102. The client devices 110 may comprise, but are not limited to, remote devices, workstations, computers, general-purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multiprocessor systems, microprocessor-based or programmable consumer electronics, game consoles, set-top boxes, network PCs, minicomputers, and the like. In further embodiments, the client devices 110 may comprise one or more of a touch screen, accelerometer, gyroscope, biometric sensor, camera, microphone, Global Positioning System (GPS) device, and the like. The client devices 110 may communicate with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi® network, a WiMAX network, another type of network, or a combination of two or more such networks.

The client devices 110 may include one or more of the applications (also referred to as “apps”) such as, but not limited to, a web browser, a book reader, a messaging application, an electronic mail (email) application, an e-commerce site application (also referred to as a marketplace application), and the like. For example, the client application(s) 107 may include various components operable to present information to the user and communicate with networked system 102. In some embodiments, if the e-commerce site application is included in a given one of the client devices 110 then this application may be configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in a given one of the client devices 110, the given one of the client devices 110 may use its web browser to access the e-commerce site (or a variant thereof) hosted on the networked system 102.

In various example embodiments, one or more users 105 may be a person, a machine, and/or other means of interacting with the client devices 110. In some example embodiments, the user 105 may not be part of the network architecture 100, but may interact with the network architecture 100 via the client devices 110 or another means. For instance, the users 105 may interact with client devices 110 that may be operable to receive input information from (e.g., using touch screen input and/or alphanumeric input) and present information to (e.g., using graphical presentation on a device display) the users 105. In this instance, the users 105 may, for example, provide input information to client devices 110 that is communicated to the networked system 102 via the network 104. The networked system 102 may, in response to the received input information, communicate information to the client device 110 via the network 104 to be presented to the users 105. In this way, the users 105 may interact with the networked system 102 using the client devices 110.

An application program interface (API) server 114 and a web server 116 may be coupled to, and provide programmatic and web interfaces respectively to, one or more application servers 118. The application servers 118 may host one or more publication system(s) 120 and payment system(s) 122, each of which may comprise one or more modules or applications and each of which may be embodied as hardware, software, firmware, or any combination thereof. The application servers 118 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system(s) 120. The database(s) 126 may also store digital goods information in accordance with example embodiments.

The publication system(s) 120 may provide a number of publication functions and services to users 105 that access the networked system 102. The payment system(s) 122 may likewise provide a number of functions to perform or facilitate payments and transactions. While the publication system(s) 120 and payment system(s) 122 are shown in FIG. 1 to both form part of the networked system 102, it will be appreciated that, in alternative embodiments, each system(s) 120 and 122 may form part of a payment service that is separate and distinct from the networked system 102. In some embodiments, the payment system(s) 122 may form part of the publication system(s) 120.

Secondary market system 123 may provide functionality to integrate a primary market and a secondary market for digital goods. The secondary market system 123 may implement ownership restrictions for the digital good, determine ownership criteria associated with the ownership restrictions, authorize a user to access the digital good, facilitate the transfer of the digital good, facilitate the purchase of the digital good, allocate a commission for the purchase of the digital good, determine a price for the digital good, maintain a price floor for the digital good, and so on.

Further, while the client-server-based network architecture 100 shown in FIG. 1 employs a client-server architecture, the present inventive subject matter is, of course, not limited to such an architecture, and may equally well find application in a distributed, or peer-to-peer, architecture system, for example. The various publication and payment systems 120 and 122 may also be implemented as standalone software programs, which do not necessarily have networking capabilities.

The web client 106 may access the various publication and payment system(s) 120 and 122 via the web interface supported by the web server 116. Similarly, the programmatic client 108 accesses the various services and functions provided by the publication and payment system(s) 120 and 122 via the programmatic interface provided by the API server 114. The programmatic client 108 may, for example, be a seller application (e.g., the Turbo Lister application developed by eBay® Inc., of San Jose, Calif.) to enable sellers to author and manage listings on the networked system 102 in an offline manner, and to perform batch-mode communications between the programmatic client 108 and the networked system 102.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102.

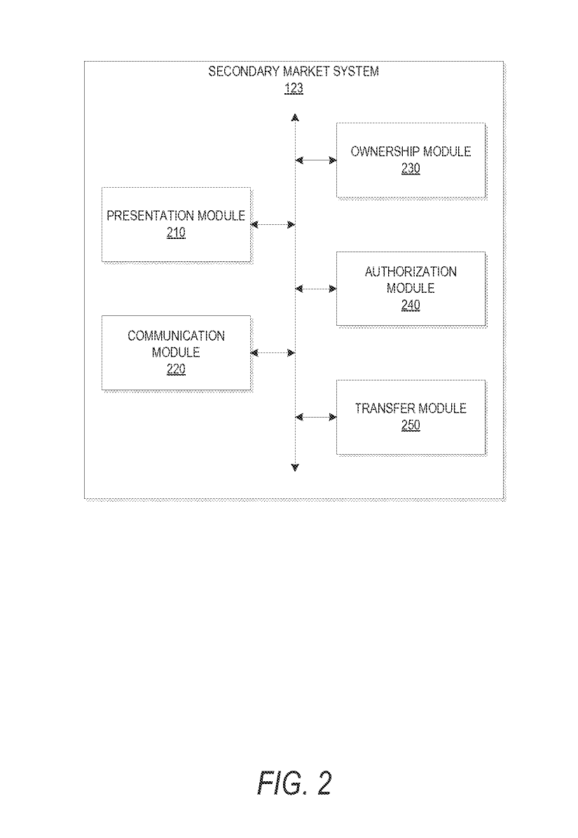

FIG. 2 is a block diagram of the secondary market system 123, which may provide functionality to integrate a primary market and a secondary market for digital goods. In an example embodiment, the secondary market system 123 may include a presentation module 210, a communication module 220, an ownership module 230, an authorization module 240, and a transfer module 250. All, or some, of the modules 210-250 may communicate with each other, for example, via a network coupling, shared memory, and the like. It will be appreciated that each module of modules 210-250 may be implemented as a single module, combined into other modules, or further subdivided into multiple modules. Other modules not pertinent to example embodiments may also be included, but are not shown.

The presentation module 210 may provide various user interface and presentation functionality operable to interactively present and receive information from users. For example, the presentation module 210 may provide a user interface configured to receive the command request from a particular user. Information may be presented using a variety of means including visually displaying information and using other device outputs (e.g., acoustic, haptic). Similarly, information may be received via a number of different means including alphanumeric input, cursor input, tactile input, or other input (e.g., one or more touch screen, camera, tactile sensors, light sensors, infrared sensors, biometric sensors, microphone, gyroscope, accelerometer, other sensors). It will be appreciated that the presentation module 210 may provide many other user interfaces to facilitate functionality described herein. Presenting is intended to include communicating information to another device with functionality operable to perform presentation using the communicated information. Interactively presenting is intended to include the exchange of information from a device and a user via a user interface.

The communication module 220 may provide various communications functionality and web services. For example, network communication such as communicating with networked system 102, the database server(s) 124, and the third party server(s) 130 may be provided. In various example embodiments, network communication may operate over wired and/or wireless means. Web services are intended to include retrieving information from third party server(s) 130 and application server(s) 118. Information retrieved by the communication module 220 may comprise data associated with the user 105 (e.g., user profile information from an online account, social networking data associated with the user 105, and so forth), data associated with an item listed on an e-commerce website (e.g., images of the item, reviews of the item, and so forth), and other data.

The ownership module 230 may determine ownership criteria associated with the ownership restrictions. Various actions and authorizations may be performed based, at least in part, on the determined ownership criteria. For example, the ownership restrictions may include a transfer limitation restriction that may prevent the transfer of the digital good after a predefined number of transfers (e.g., one-time transfer). The ownership criteria may include a criterion based on a count of the transfers of the digital good. In this instance, the ownership criteria may indicate that the digital good has exceeded the predefined number of transfers.

The authorization module 240 may perform various authorization functions such as authorizing users to access the digital good and de-authorizing users from access to the digital good. For example, the authorization module 240 may authorize various users to access the digital good, based, at least in part, on the ownership criteria.

The transfer module 250 may facilitate the transfer of the digital good between various entities. For example, a first user may request to transfer the digital good (e.g., a purchase request initiated on an e-commerce website that includes a listing for the digital good in a secondary and/or primary market). In response to the transfer request from the first user, the transfer module 250 may facilitate the transfer of the digital good to the first user. In another example, a second user may request to sell or gift the digital good that, in this example, may be owned by the second user. The transfer module 250 may facilitate the transfer of the digital good from the second user to the first user.

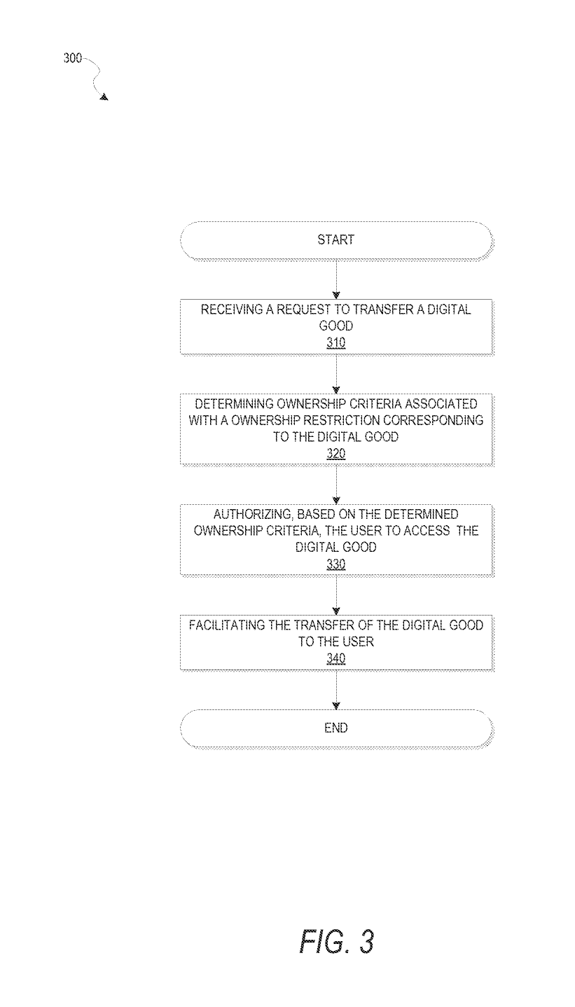

FIG. 3 is a flow diagram illustrating an example method 300 for managing a secondary market for digital goods, according to example embodiments. The secondary market is intended to include pre-owned digital goods (e.g., used digital goods). The primary market is intended to include digital goods that have not been previously owned. The operations of the method 300 may be performed by components of the secondary market system 123. It will be appreciated that digital goods are intended to include a wide variety of media forms including eBooks, audio books, movies, music, and so forth. At operation 310, the communication module 220 may receive a request to transfer the digital good. For example, a first user may initiate a request for the digital good, at a first user device, by selecting a listing for the digital good from a plurality of listings published on an e-commerce website. In some example embodiments, a second user, who may currently own the digital good, may have listed the digital good for sale at the secondary market on an e-commerce website.

In various example embodiments, the digital good may be subject to an ownership restriction, and/or multiple ownership restrictions, stored in association with the digital good. The ownership restriction may be information stored, for example, in the digital good (e.g., embedded in the digital good), locally on a device (e.g., client device(s) 110), in a separate file, in a database, in an application server (e.g., online marketplace system 120), in a third party server, or elsewhere. In an example embodiment, the ownership module 230 may manage and implement the ownership restriction for the digital good. In some example embodiments, the ownership module 230 may provide information about the ownership restriction for presentation to a particular user such as the first user or another user interested in acquiring the digital good.

The ownership restriction may be one of many different types of ownership restrictions. In an example embodiment, the ownership restriction may be a transfer restriction that limits the number of transfers of the digital good. For instance, the transfer restriction may limit the number of transfers of the digital good to a designated number of transfers. The designated number of transfers may be a predetermined number. In various example embodiments, the ownership module 230 may update the ownership restriction, stored in association with the digital good, for each transfer of the digital good. In this way, the digital good that may be subject to the transfer restriction may be transferred a limited number of times and thereafter prevented from being transferred.

In further example embodiments, the ownership restriction may be a temporal restriction. For example, the ownership restriction may be a time restriction that may allow for the transfer of the digital good within a designated time period and/or prevent the transfer of the digital good within another designated time period. In a specific example, the temporal restriction may allow the transfer of the digital good within a one-year time period that begins when the digital good may be transfer to the user. In this example, the digital good may not be transferred once the time period has expired. The ownership restrictions may include many other variations and types of time-based limitations. In another example embodiment, the temporal restriction may be such that the digital good may expire and no longer be accessible to some entities after expiration. For example, the temporal restriction may allow for the digital good to be accessible for a five-year period that begins on the date the digital good was first transferred. The ownership module 230 may determine the starting time and duration of the temporal restriction using a variety of schemes. For instance, the ownership module 230 may determine the start time for the temporal restriction to be the time of transfer of the digital good or dynamically determined.

In still further example embodiments, the ownership restriction may be a combination of the temporal restriction and the transfer restriction. For instance, the number of transfers of the digital good may be limited to a transfer limit that is dependent on time. In a specific instance, the transfer limit may be a designated number of transfers that replenishes with time (e.g., five transfers allowed total with no more than one transfer per year). Many varieties of the transfer restriction with a time-based component may be employed.

In further example embodiments, various ownership restrictions may be triggered by a variety of events. In this example embodiment, the ownership restriction may not be active until triggered by a restriction event. The ownership module 230 may monitor for the restriction event and activate the ownership restriction upon detecting and/or receiving the restriction event. For instance, if the digital good is an eBook and a new version of the eBook is released, the release of the new version may be the restriction event that may activate the ownership restriction in the digital good. In this example, the release of the new version of the eBook may trigger a particular temporal restriction, such as a time period in which to sell the digital good, to become active. A wide variety of events may be restriction events such as a change in market price for the digital good (e.g., the ownership module 230 monitoring the market price of the digital good on an e-commerce website), a transfer of the digital good from one entity to another, a release of a complementary good (e.g., release of a sequel to an eBook and/or release of a movie based on an eBook), other market factors (e.g., death of an author of the eBook as monitored by the ownership module 230), and so on.

In yet further example embodiments, the ownership restriction may be an entity restriction that limits the entity or entity type that the digital good may be transferred to. For instance, the entity restriction may prevent the transfer of the digital good to an entity that is not a person and/or does not belong to a designated group (e.g., a non-member of an e-commerce website). In some example embodiments, the ownership restriction may be entity-specific. For instance, an entity with particular characteristics or attributes may be qualified to receive the transfer of the digital good (e.g., an entity that does not already own the same or similar digital good). Many different characteristics or attributes of a particular entity may be analyzed to determine that the entity may receive the transfer of the digital good.

Many other varieties of ownership restrictions may be implemented to restrict and/or limit ownership and/or prevent user actions associated with the digital good. Further examples may include copy restrictions (e.g., limit copying of the digital good), machine use restrictions (e.g., only a certain number of machines may use the digital good and/or only certain types of machines may use the digital good), and so on.

The ownership restriction may be implemented using a variety of schemes and techniques. Many different devices may enforce and/or implement the ownership restrictions. For instance, an application server (e.g., marketplace system(s) 120 or secondary market system 123) may enforce the ownership restriction in a scheme where the client device (e.g., client devices 110) requests permission (e.g., access to the digital good) from the application server and the application server may grant or deny the permission based on various criteria. In another example, the ownership restriction may be stored locally on the client devices 110 and the client devices 110 may determine whether to enforce the ownership restriction based on various criteria. Many other schemes and techniques may be employed to implement the ownership restriction.

In various example embodiments, the ownership module 230 may maintain a finite supply of the digital good. The finite supply of the digital good may be maintained at various operations of method 300 associated with the digital good. The finite supply of the digital good may be a fixed number of instances of the digital good. In an example embodiment, the transferring of the digital good may include maintaining the finite supply. For example, simply copying the digital good may increase the supply. Duplicative instances of the digital good may be inhibited using various schemes and techniques to maintain the finite supply of the digital good. In an example embodiment, the finite supply may be maintained by deleting the duplicative instances of the digital good (e.g., communicate the digital good from a first device to a second device and deleting the digital good stored in the first device). In another example embodiment, the finite supply may be maintained by controlling access to the digital good (e.g., the duplicative instances of the digital good may exist, but access may only be provided to some of the instances of the digital good to maintain the finite supply). Access to the digital good may be controlled using various techniques including encryption and decryption schemes. Other digital rights management techniques may be implemented to maintain a finite supply of the digital good. Many other schemes and techniques may be implemented to maintain the finite supply of the digital good.

At operation 320, the ownership module 230 may determine ownership criteria associated with the ownership restriction. In some example embodiments, the ownership criteria may be associated with satisfying the ownership restriction. For example, if the ownership restriction is a particular transfer restriction, the ownership criteria may be whether the transfer limit has been exceeded. Similarly, if the ownership restriction is an entity or machine-based restriction, the ownership criteria may include criteria associated with the entity or machine that the digital good may be transferred to. In further example embodiments, the ownership module 230 may determine a variety of other ownership criteria.

At operation 330, the authorization module 240 may authorize, based at least in part on the ownership criteria, the first user to access the digital good. For example, if the ownership criteria are satisfied (e.g., the number of transfers is less than the designated number of transfers), the authorization module 240 may authorize the first user to access the digital good. In some example embodiments, the authorization module 240 may de-authorize the second user (e.g., the owner of the digital good) from accessing the digital good. In further example embodiments, the authorization module 240 may authorize or de-authorize various actions associated with the digital good. For instance, the authorization module 240 may de-authorize a particular entity from accessing a portion of the digital good. In another instance, the authorization module 240 may authorize and/or de-authorize a particular entity from using the digital good with a particular device. The authorization module 240 may authorize and/or de-authorize a wide variety of actions associated with the digital good.

At operation 340, the transfer module 250 may facilitate transfer of the digital good to the first user. For example, the transfer of the digital good may be a digital download of the digital good, a streaming of the digital good, transferring of the digital good from one device to another (e.g., via a peer-to-peer connection or wired and/or wireless connection), and so on. The transfer module 250 may employ a variety of schemes to facilitate transferring of the digital good.

In further example embodiments, the transfer of the digital good may comprise a purchase of the digital good by the first user for a price. For example, the second user may own the digital good and sell the digital good to the first user for a price. In this example, the second user may list the digital good for sale at an e-commerce website, make a direct sale to the first user, and/or employ another sale structure (e.g., third party escrow).

In further example embodiments, the transfer module 250 may add a commission to the price of the digital good. The transfer module 250 may allocate at least a portion of the commission to the publisher of the digital good, the distributor of the digital good, and/or another entity. The allocation of the commission may be predetermined or determined dynamically. For instance, the allocation may be a fixed percentage of the commission allocated to the distribution and publisher. In another instance, the commission may be determined based on the ownership restriction (e.g., as the transfer count increases the commission for the publisher may decrease). A variety of schemes may be employed to determine the commission based on the ownership restriction.

In an alternative example embodiment, the second user, who may currently own the digital good, may gift the digital good to a designated user. The gift may not require the designated user to pay for the digital good. The gifting of the digital good by the second user may not be allowed without designating a recipient of the gift (e.g., may not simply gift the digital good to any consumer). The transfer module 250 may facilitate the gifting of the digital good.

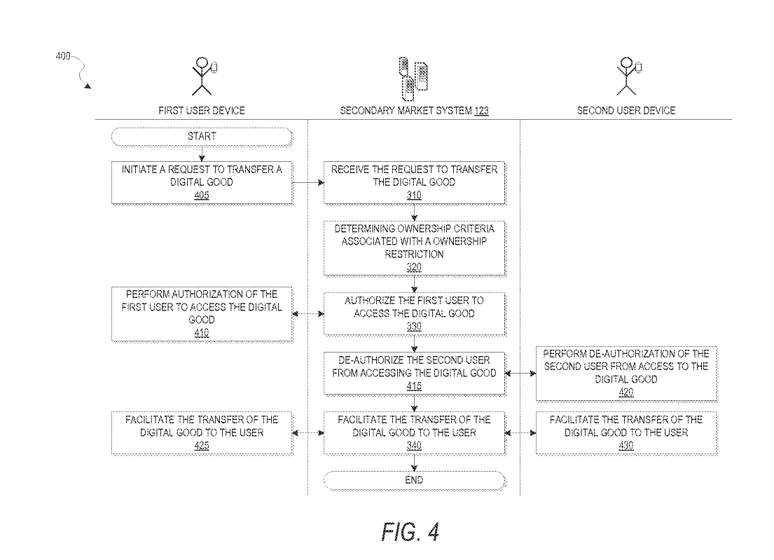

FIG. 4 is a flow diagram illustrating communication between devices that may transfer the digital good from the second user to the first user, according to example embodiments. The operations of the method 400 may be performed by components of the secondary market system 123. At operation 405, the first user may initiate a request to transfer the digital good at a first user device. For instance, the first user may be browsing an e-commerce website that includes a listing for the digital good. The first user may initiate the request to transfer the digital good at the e-commerce website by selecting the listing for the digital good.

At the operation 310, the communication module 220 may receive the request to transfer the digital good, as described above. The request to transfer the digital good may include various information such as an identifier corresponding to the first user, an identifier corresponding to the digital good, an identifier corresponding to the second user (e.g., the owner of the digital good), and various other information that may be used to facilitate the transfer of the digital good.

At the operation 320, the ownership module 230 may determine ownership criteria associated with the ownership restriction, as described above. The ownership module 230 may retrieve information associated with the first user, the second user, the digital good, and/or other information to determine the ownership criteria. For example, the ownership criteria may be associated with the transfer restriction that limits the number of transfers of the digital good. The ownership module 230 may retrieve information that specifies the number of times the digital good has been transferred. The information that specifies the number of times the digital good has been transferred may be stored at, for example, the first user device, the secondary market system 123, third-party servers, and/or elsewhere.

At the operation 330, the authorization module 240 may authorize, based at least in part on the ownership criteria, the first user to access the digital good, as described above. In some example embodiments, the first user may be authorized to access the digital good by modifying the digital good such that the digital good is accessible to the first user (e.g., unlocking the digital good). Many other schemes and techniques may be employed to authorize entities to access the digital good and control access to the digital good.

At operation 410, the first user device may perform authorization of the first user to access the digital good, in accordance with some example embodiments. For example, the authorization module 240 may communicate an authorization message to the first user device that may be used to authorize the first user to access the digital good. The authorization message may include a variety of information to facilitate authorization of the first user. Many other schemes and techniques may be used to authorize the first user to access the digital good.

At operation 415, the authorization module 240 may de-authorize the second user from accessing the digital good. For example, if the second user owns the digital good and has listed the digital good for sale on an e-commerce website, the authorization module 240 may de-authorize the second user from accessing the digital good once the digital good is sold or transferred.

At operation 420, the second user device may perform de-authorization of the second user from accessing the digital good. For example, the authorization module 240 may communicate a de-authorization message to the second user device that may be used to de-authorize the second user from access to the digital good. The de-authorization message may include a variety of information used to facilitate de-authorization of the second user. Many other schemes and techniques may be used to de-authorize the second user from access to the digital good.

At the operation 340, the transfer module 250 may facilitate transfer of the digital good to the first user, as described above. At the operation 340, the transfer module 250 may communicate with the first user device that may, at operation 425, facilitate the transfer of the digital good to the user. Similarly, at the operation 340, the transfer module 250 may communicate with the second user device that may, at operation 430, facilitate the transfer of the digital good to the user. Many different modalities of transfer may be employed to transfer the digital good to the first user. In some example embodiments, the digital good may be deleted from the second user device.

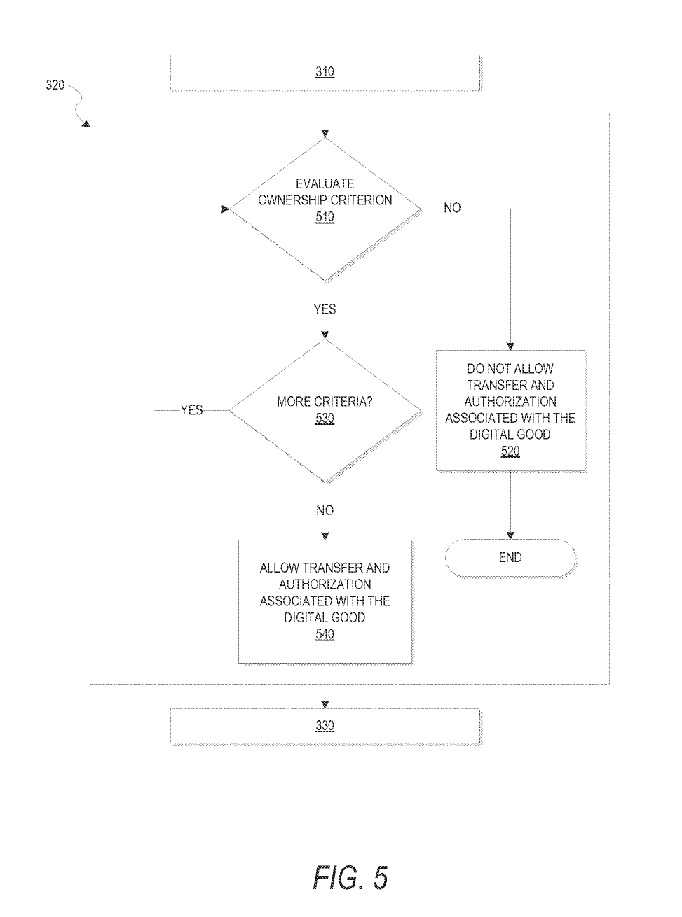

FIG. 5 is a flow diagram illustrating an example embodiment for operation 320 for determining ownership criteria. The ownership criteria may include one or more ownership criteria associated with the ownership restriction. In an example embodiment, at operation 510, the ownership module 230 may evaluate each, or some, of the one or more ownership criteria (e.g., determine whether the ownership criterion is satisfied). The evaluation of the ownership criteria may be used to perform or prevent actions associated with the digital good.

In an example embodiment, at operation 520, the ownership module 230 may not allow the transfer of the digital good and/or the authorizing of access to the digital good if, for example, the ownership criterion is not satisfied at the operation 510. For instance, if the ownership criteria include a particular ownership criterion that has not been satisfied, then actions associated with the digital good may be prevented.

At operation 530, the ownership module 230 may determine whether there are more ownership criteria included in the ownership criteria to evaluate at operation 510. In some example embodiments, each ownership criterion included in the ownership criteria may be evaluated at operation 510. In other embodiments, only some ownership criteria included in the ownership criteria may be evaluated at operation 510.

When there are no more criteria to evaluate at the operation 510, then at operation 540, the ownership module 230 may allow the transfer of the digital good and the authorization of access to the digital good. For instance, if the ownership criteria are satisfied at operation 510, then the digital good may be transferred at the operation 340 and authorizing access to the digital good may be performed at the operation 330.

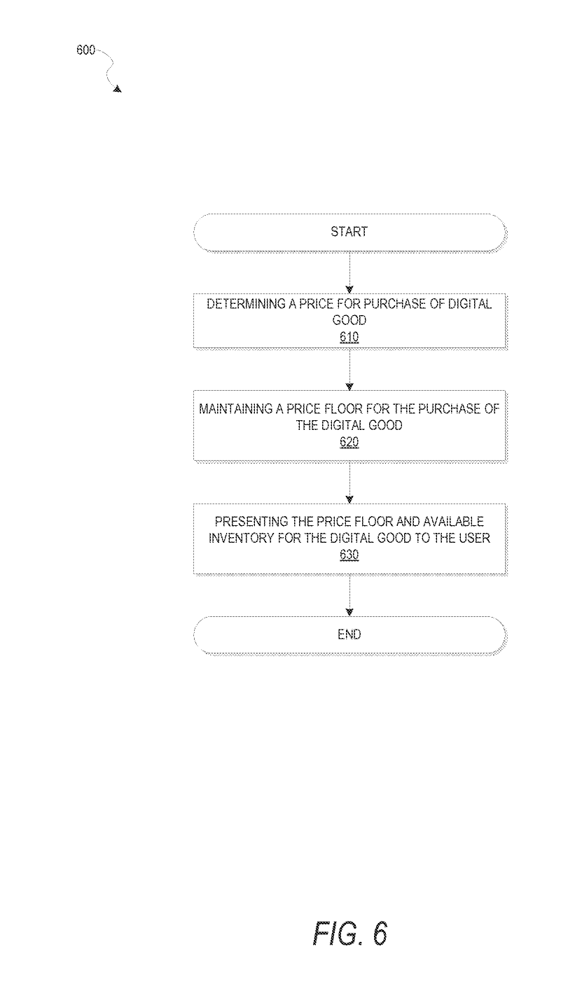

FIG. 6 is a flow diagram illustrating determining a price for the digital good, according to example embodiments. The operations of the method 600 may be performed by components of the secondary market system 123. At operation 610, the transfer module 250 may determine a price for the purchase of the digital good. The transfer module 250 may determine the price for the digital good based on a variety of factors that may be associated with the ownership restrictions included with the digital good. For example, if the digital good is not subject to any, or very few, ownership restrictions, then the price may be higher than for a particular digital good that is associated with many ownership restrictions. Many other factors may be used to determine the price of the digital good. For example, the number of digital goods in the inventory that are the same or similar (e.g., similar ownership restrictions) to the digital good may be a factor in determining the price for the digital good (e.g., a large supply of the same or similar digital goods may reduce the price for the digital good). For instance, the transfer module 250 may retrieve inventory information associated with the digital good from the secondary market system 123 to be used to determine the price for the digital good.

In further example embodiments, the transfer module 250 may determine the price for the digital good by using a supply and demand model where the supply may be determined based on the number of same or similar digital goods in the inventory. The transfer module 250 may determine demand for the digital good using various proxies that may provide an indication of the demand for the digital good, including, for instance, hits to a website associated with the digital good, demand for similar or associated digital goods or products, and so on.

At operation 620, the transfer module 250 may maintain a price floor for the purchase of the digital good. The price floor may be a minimum price that the digital good may be sold for. The purpose of the price floor is to prevent the price of the digital good from falling to zero or near zero in an unconstrained pricing scheme. Preventing the price from falling to zero or near zero may provide credibility to the market for the digital good since the digital good may be a homogenous good that is the same or similar to another digital good. The price floor may be predetermined or dynamically determined. For example, the price floor may be dynamically determined based on trends in the digital good market (e.g., an average price for similar digital goods).

At operation 630, the transfer module 250 may present the price floor and/or available inventory for the digital good to the first user. Providing awareness to consumers, such as the first user, of the price floor and available inventory of the digital good may further provide credibility to the secondary and primary market for the digital good. A particular consumer, such as the first user, may then decide whether to purchase a particular digital good with many ownership restrictions (e.g., from the secondary market) at a lower price or few ownership restrictions (e.g., from the primary market) at a higher price.

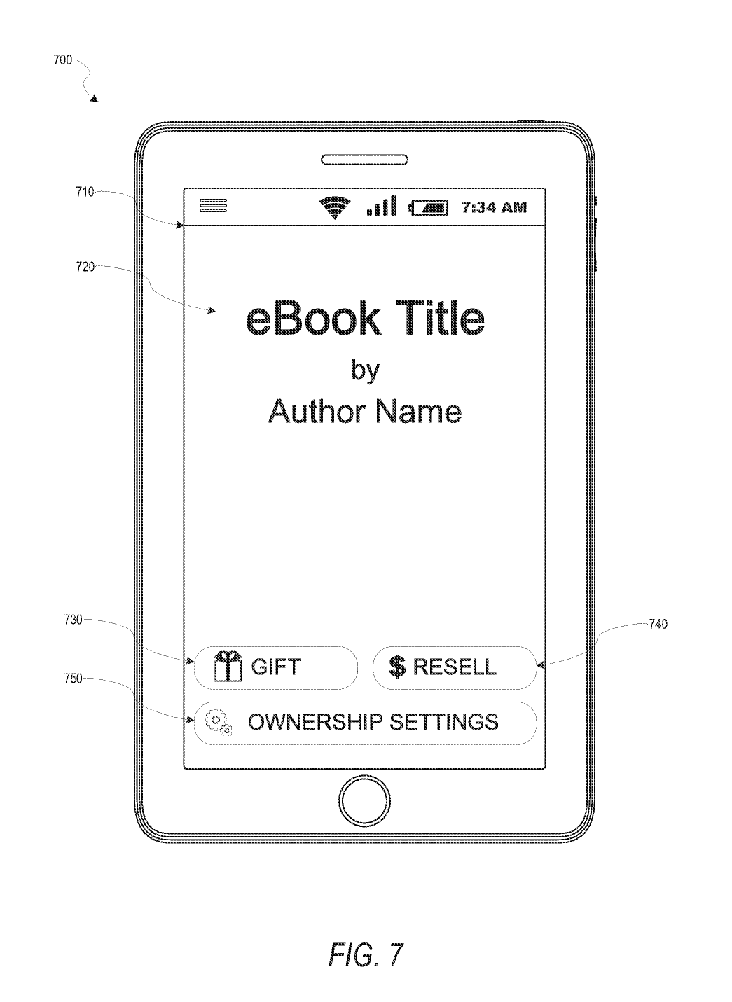

FIG. 7 illustrates an example embodiment of a presentation device 700 (e.g., eBook reader, tablet computer, smartphone) operable to present the digital good to users. The presentation device 700 may include a display 710, although the digital good may be of a media form that requires no display 710 (e.g., audio). The presentation device 700 may display and/or present the digital good 720 to a user. In this example, the digital good 720 may be an eBook. User interface element 730 may be a button that, upon activation, may provide the user with the option to gift the digital good to a user-specified entity. User interface element 740 may be a button that, upon activation, may provide the user with the option to sell the digital good, for example, on a secondary marketplace provided by the secondary marketplace system 123. User interface element 750 may be a button that, upon activation, may present the user with ownership information corresponding to the digital good such as ownership restrictions. The user interface element 750 may also provide the user with the option to modify the ownership restrictions for a price.

### Modules, Components, and Logic

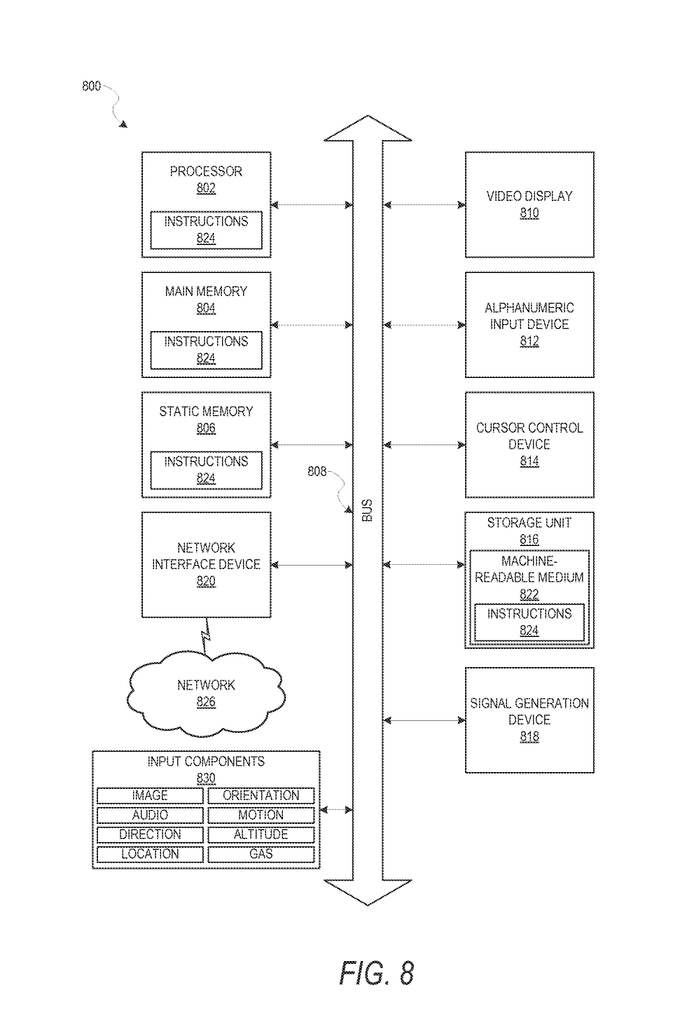

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 824 (e.g., software, a program, an application, an applet, an app, or other executable code) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include a collection of machines 800 that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application-specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light-emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the static memory 806, within the processor 802 (e.g., within the processor's cache memory), or all three, during execution thereof by the machine 800. Accordingly, the main memory 804, static memory 806 and the processor 802 may be considered as machine-readable media 822. The instructions 824 may be transmitted or received over a network 826 via the network interface device 820.

In some example embodiments, the machine 800 may be a portable computing device, such as a smart phone or tablet computer, and have one or more additional input components 830 (e.g., sensors or gauges). Examples of such input components 830 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., instruction 824) for execution by a machine (e.g., machine 800), such that the instructions, when executed by one or more processors of the machine 800 (e.g., processor 802), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 822 is non-transitory in that it does not embody a propagating signal. However, labeling the machine-readable medium 822 as “non-transitory” should not be construed to mean that the medium is incapable of movement; the medium should be considered as being transportable from one physical location to another. Additionally, since the machine-readable medium 822 is tangible, the medium may be considered to be a machine-readable device.

The instructions 824 may further be transmitted or received over a communications network 826 using a transmission medium via the network interface device 820 and utilizing any one of a number of well-known transfer protocols (e.g., hypertext transfer protocol (HTTP)). Examples of communication networks include a local area network (LAN), a wide area network (WAN), the Internet, mobile telephone networks (e.g. 3GPP, 4G LTE, 3GPP2, GSM, UMTS/HSPA, WiMAX, and others defined by various standard setting organizations), plain old telephone service (POTS) networks, and wireless data networks (e.g., Wi-Fi® and Bluetooth® networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via the network 826 (e.g., the Internet) and via one or more appropriate interfaces (e.g., an application program interface (API)).

The performance of certain of the operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a communication module to receive, from a first user, a request to transfer a digital good for a transfer price, the digital good being subject to an ownership restriction stored in association with the digital good and a price restriction that maintains a price floor for a plurality of digital goods including the digital good;
an ownership module, executable by at least one processor of a machine, to determine satisfaction of ownership criteria associated with the ownership restriction;
a transfer module to determine the transfer price exceeds the price floor;
in response to determining satisfaction of the ownership criteria and the transfer price exceeding the price floor:
an authorization module to authorize, based at least in part on the ownership criteria, the first user to access the digital good; and
the transfer module to facilitate the transfer of the digital good to the first user, the transfer of the digital good comprising a purchase of the digital good by the first user for the transfer price.

2. (canceled)

3. The system of claim 1, wherein:
the transfer module further to:
add a commission to the transfer price; and
allocate at least a portion of the commission to a publisher of the digital good and a distributor of the digital good.

4. The system of claim 1, wherein:
the transfer module further to determine the transfer price based, at least in part, on the ownership restriction.

5. The system of claim 1, wherein:
the transfer module further to determine the transfer price based on an available inventory of the digital good, wherein the available inventory includes a plurality of similar digital goods subject to a plurality of ownership restrictions; and
a presentation module to present the available inventory to the first user.

6. (canceled)

7. The system of claim 1, wherein the ownership restriction comprises a temporal restriction that limits a time for the purchase of the digital good to a designated time period.

8. A method comprising:
receiving, from a first user, a request to transfer a digital good for a transfer price, the digital good being subject to an ownership restriction stored in association with the digital good and a price restriction that maintains a price floor for a plurality of digital goods including the digital good;
determining, using a processor of a machine, satisfaction of ownership criteria associated with the ownership restriction;
determining the transfer price exceeds the price floor;
in response to determining satisfaction of the ownership criteria and the transfer price exceeding the price floor;
authorizing, based, at least in part on the ownership criteria, the first user to access the digital good; and
facilitating the transfer of the digital good to the first user, the transfer of the digital good comprising a purchase of the digital good by the first user for the transfer price.

9. (canceled)

10. The method of claim 8, further comprising:
adding a commission to the transfer price; and
allocating at least a portion of the commission to a publisher of the digital good and a distributor of the digital good.

11. The method of claim 8, further comprising:
determining the transfer price based, at least in part, on the ownership restriction.

12. The method of claim 8, further comprising:
determining the transfer price based on an available inventory of the digital good, the available inventory including a plurality of similar digital goods subject to a plurality of ownership restrictions; and
presenting the available inventory to the first user.

13. (canceled)

14. The method of claim 8, wherein the ownership restriction comprises a temporal restriction that limits the time for the purchase of the digital good to a designated time period.

15. The method of claim 8, wherein the ownership restriction comprises a transfer restriction that limits the number of transfers of the digital good to a predefined number of transfers.

16. The method of claim 8, further comprising:
receiving, from a second user, a request to sell the digital good, the second user owning the digital good; and
in response to the transferring the digital good to the user, de-authorizing the second user from accessing the digital good.

17. The method of claim 8, wherein the transfer comprises a gift transfer that specifies the first user as a recipient of the digital good.

18. The method of claim 8, further comprising:
updating the ownership restriction based on the determined ownership criteria.

19. The method of claim 8, wherein the digital good comprises an eBook.

20. A machine readable medium not having any transitory signals and storing instructions that, when executed by at least one processor of a machine, cause the machine to perform operations comprising:
receiving, from a first user, a request to transfer a digital good for a transfer price, the digital good being subject to an ownership restriction stored in association with the digital good and a price restriction that maintains a price floor for a plurality of digital goods including the digital good;
determining satisfaction of ownership criteria associated with the ownership restriction;
determining the transfer price exceeds the price floor;
in response to determining satisfaction of the ownership criteria and the transfer price exceeding the price floor:
authorizing, based, at least in part on the ownership criteria, the first user to access the digital good; and
facilitating the transfer of the digital good to the first user, the transfer of the digital good comprising a purchase of the digital good by the first user for the transfer price.
